(19) United States
(12) Patent Application Publication
(10) Pub. No.: US 2019/0004567 A1
(43) Pub. Date: Jan. 3, 2019

(54) DISPLAY DEVICE AND ASSEMBLING METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: ZHAOHUI ZHOU, Santa Clara, CA (US); PING-HAO LIU, New Taipei (TW); FA-MING WU, Shenzhen (CN); XUE-QIN ZHANG, Shenzhen (CN)

(21) Appl. No.: 15/689,715

(22) Filed: Aug. 29, 2017

(30) Foreign Application Priority Data
Jun. 30, 2017 (CN) 201710524489.6

(51) Int. Cl. G06F 1/16; G06F 3/041

(52) U.S. Cl. CPC G06F 1/1643; G06F 2203/04103; G06F 3/041

(57) ABSTRACT

A display device includes a shell, a displaying module, and a touch plate. The shell defines a receiving space and includes a frame and two connecting strips horizontally extending from two fixed sides of the frame. The displaying module is received in the receiving space. The touch plate is received in the receiving space and includes a touch sensor member and a touch glass member. A touch glass layer is overlapped on the touch sensor layer. Two ends of the touch glass layer extend out of the touch sensor layer and are attached to an upper surface of the two connecting strips. The disclosure further provides a method for assembling the display device.

### CROSS-REFERENCE TO RELATED APPLICATIONS

This application claims priority to Chinese Patent Application No. 201710524489.6, filed on Jun. 30, 2017, the contents of which are incorporated by reference herein.

### FIELD

The subject matter herein generally relates to display devices.

### BACKGROUND

Display devices include a shell, a displaying module, and a touch plate. The shell includes a frame and two opposite restricting strips extending from two sides of the frame. The displaying module is received in the shell. The touch plate is attached between the displaying module and the restriction strip.

### BRIEF DESCRIPTION OF THE DRAWING

Implementations of the present technology will now be described, by way of example only, with reference to the attached drawing.

FIG. 1 is a cross-sectional view of a display device, according to an exemplary embodiment of the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein. The disclosure is illustrated by way of example and not by way of limitation in the figures of the accompanying drawings, in which like references indicate similar elements. It should be noted that references to “an” or “one” exemplary embodiment in this disclosure are not necessarily to the same exemplary embodiment, and such references mean “at least one.”

The term “comprising” means “including, but not necessarily limited to”; it specifically indicates open-ended inclusion or membership in a so-described combination, group, series, and the like.

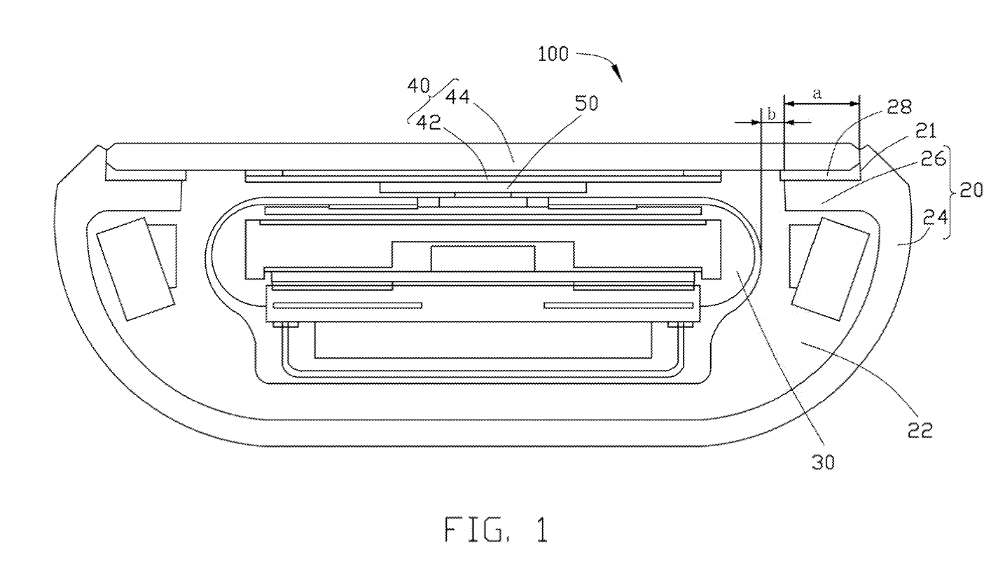

FIG. 1 illustrates a cross-sectional view of a display device 100, which includes a shell 20, a displaying module 30 and a touch plate 40. The shell 20 includes a receiving space 22. The displaying module 30 and the touch plate 40 are fixed in the receiving space 22 to form the display device 100.

The shell 20 includes a frame 24 and two opposite connecting strips 26 horizontally extending from two fixed sides 21 of the frame 24. The touch plate 40 includes a touch sensor layer 42 and a touch glass layer 44. The touch glass layer 44 is overlapped on the touch sensor layer 42. A length of the touch glass layer 44 is longer than a length of the touch sensor layer 42. Two ends of the touch glass layer 44 extend out of the touch sensor layer 42. Two ends of the touch glass layer 44 are attached to an upper surface of the two connecting strips 26. The touch glass layer 44 is attached to the connecting strip 26 by an adhesive 28. The adhesive 28 is positioned between the touch glass layer 44 and the connecting strip 26.

An end of the fixed side 21 and an upper surface of the touch glass layer 44 are in the same plane. A length of the touch glass layer 44 overlapping with the connecting strip 26 is a first length “a”. In another embodiment, the connecting strip 26 extends from the end of the fixed side 21. The two ends of the touch glass layer 44 overlap the end of the two fixed sides 21.

The touch plate 40 is situated on the displaying module 30. An end of the displaying module 30 is at a distance (second length “b”) from the end of the connecting strip 26 along a direction parallel to the touch glass layer 44. In an embodiment, the first length “a” is 1.751 millimeters. The second length “b” is 0.585 millimeters.

In an embodiment, the touch plate 40 is attached to the displaying module 30 through a liquid optically clear adhesive 50. The liquid optically clear adhesive 50 is positioned between the touch sensor layer 42 and the displaying module 30.

When assembling the display device 100, the touch plate 40 is attached to the displaying module 30 through the liquid optically clear adhesive 50 and then the touch glass layer 44 is attached to the connecting strip 26 to be attached to the shell 20. In an embodiment, the adhesive 28 is positioned on the upper surface of the connecting strip 26. The touch glass layer 44 is attached to the connecting strip 26 through the adhesive 28 positioned on the upper surface of the connecting strip 26. In another embodiment, the adhesive 28 is positioned on the inside of the touch glass layer 44. The touch glass layer 44 is attached to the connecting strip 26 through the adhesive 28 positioned on the inside of the end of the touch glass layer 44 opposite to the touch sensor layer 42.

The exemplary embodiments shown and described above are only examples. Even though numerous descriptions and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A display device comprising:
a shell defining a receiving space and comprising a frame and two connecting strips horizontally extending from two fixed sides of the frame;
a displaying module received in the receiving space; and
a touch plate received in the receiving space and comprising a touch sensor member and a touch glass member, the touch glass layer overlapped on the touch sensor layer, two ends of the touch glass layer extending out of the touch sensor layer and attached to an upper surface of at least one of the two connecting strips.

2. The display device as claimed in claim 1, wherein the touch glass layer is attached to at least one of the two connecting strips through an adhesive.

3. The display device as claimed in claim 2, wherein the adhesive is positioned between the touch glass layer and the at least one of the two connecting strips.

4. The display device as claimed in claim 1, wherein the touch plate is attached to the displaying module through a liquid optical clear adhesive, the liquid optical clear adhesive is positioned between the touch sensor layer and the displaying module.

5. The display device as claimed in claim 1, wherein the touch glass layer overlaps at least one of the two connecting strips.

6. The display device as claimed in claim 1, wherein an end of the fixed side and the touch glass layer are in a same plane, a length of the touch glass layer overlapped on the connecting strip is a first length.

7. The display device as claimed in claim 6, wherein the touch plate is attached on the displaying module, an end of the displaying module is spaced from at least one of the two connecting strips by a second length, along a direction parallel to the touch glass layer.

8. The display device as claimed in claim 7, wherein the first length is about 1.751 millimeters, the second length is about 0.585 millimeters.

9. A display device comprising:
a shell defining a receiving space and comprising a frame and two connecting strips horizontally extending from two fixed sides of the frame;
a displaying module received in the receiving space; and
a touch plate received in the receiving space and comprising a touch sensor member and a touch glass member, the touch glass layer positioned on the touch sensor layer, two ends of the touch glass layer attached to an upper surface of at least one of the two connecting strips, the touch sensor layer and the two connecting strips being aligned.

10. The display device as claimed in claim 9, wherein the touch glass layer is attached to at least one of the two connecting strips through an adhesive.

11. The display device as claimed in claim 10, wherein the adhesive is positioned between the touch glass layer and the at least one of the two connecting strips.

12. The display device as claimed in claim 9, wherein the touch plate is attached to the displaying module through a liquid optical clear adhesive, the liquid optical clear adhesive is positioned between the touch sensor layer and the displaying module.

13. The display device as claimed in claim 9, wherein the touch glass layer overlaps at least one of the two fixed sides.

14. The display device as claimed in claim 9, wherein an end of the fixed side and the touch glass layer are in a same plane, a length of the touch glass layer overlapped on the connecting strip is a first length.

15. The display device as claimed in claim 14, wherein the first length is about 1.751 millimeters.

16. The display device as claimed in claim 14, wherein the touch plate is attached on the displaying module, an end of the displaying module is spaced from at least one of the two connecting strips by a second length, along a direction parallel to the touch glass layer.

17. The display device as claimed in claim 16, wherein the second length is about 0.585 millimeters.

18. A method for assembling a display device, the display device comprising a shell, the shell comprising a frame and two connecting strips horizontally extending from two fixed sides of the frame, the method comprising:
connecting a touch plate of the display device to a displaying module of the display device through a liquid optical clear adhesive; and
connecting touch glass layer of the touch plate to the connecting strip to be received in a receiving space defined by the shell.

19. The method as claimed in claim 18, wherein an adhesive is positioned on an outside of at least one of the connecting strips, the touch glass layer is attached to the at least one of the connecting strips through an adhesive positioned on an upper surface of the at least one of the connecting strips.

20. The method as claimed in claim 18, wherein an adhesive is positioned on an inside of the touch glass layer, the touch glass layer is attached to at least one of the connecting strips through the adhesive positioned on the inside of the touch glass layer.
